(19) United States
(12) Patent Application Publication
(10) Pub. No.: US 2020/0369456 A1
(43) Pub. Date: Nov. 26, 2020

(54) PACKAGING MATERIALS AND PACKAGING SYSTEMS

(71) Applicant: PAC WORLDWIDE CORPORATION, Redmond, WA (US)

(72) Inventor: Murray FULLERTON, Papakura (NZ)

(21) Appl. No.: 16/966,344

(22) PCT Filed: Jan. 31, 2019
(86) PCT No.: PCT/US2019/016160

§ 371 Date: Jul. 30, 2020

Related U.S. Application Data
(60) Provisional application No. 62/625,027, filed on Feb. 1, 2018.

(51) Int. Cl. B65D 81/38; B32B 27/08; B32B 27/32; B32B 3/28; B65D 81/03; B32B 15/085; B32B 15/20

(52) U.S. Cl. CPC B65D 81/3897; B32B 2439/46; B32B 27/32; B32B 3/28; B65D 81/03; B32B 15/085; B32B 15/20; B32B 2250/04; B32B 2250/40; B32B 2255/10; B32B 2255/205; B32B 2307/304; B32B 2307/7244; B32B 2307/7246; B32B 2439/70; B32B 27/08

(57) ABSTRACT

Packaging materials and packaging systems can include metallized polymer films such as metallized polyethylene films having a metallic layer and a polyethylene layer, where bubbles are attached directly to the polyethylene layer and the metallic layer opposite the bubbles is exposed to an environment surrounding the material or system. The packaging materials and packaging systems can be highly recyclable and highly insulating.

### BACKGROUND

### Technical Field

The present disclosure relates generally to packaging materials and packaging systems, and more particularly to packaging materials and packaging systems that include metallized polymer films.

### Description of the Related Art

Metallized polymer films are widely available in various forms and are used in various applications. As examples, metallized polymer films are often used as decorative or insulating materials. Commercially available metallized polymer films include polyester, polypropylene, or polyethylene terephthalate metallized with aluminum, nickel, or chromium. Metallized polymer films are often fabricated using physical vapor deposition processes, in which a metal is heated, melted, and boiled or evaporated, sometimes in a vacuum, and is then allowed to condense onto a cold, sometimes statically charged, polymer film. Metallized polymer films can have very thin metallic layers, such as within the range of 0.1-1.0 or about 0.5 micrometers.

### BRIEF SUMMARY

A packaging material system may be summarized as comprising a metallized polyethylene film including a metallic layer and a polyethylene layer, and a plurality of gas-filled polyethylene bubbles coupled to the metallized polyethylene film, wherein a surface of the metallic layer of the metallized polyethylene film opposite to the polyethylene layer of the metallized polyethylene film is exposed to an environment surrounding the packaging material system.

The metallic layer may comprise aluminum. The system may be recyclable, thermally insulating, and/or a package that encloses food. The system may be a barrier to O₂ and/or H₂O. The system can include no polyester, no polypropylene, and/or no polyethylene terephthalate.

The system may further comprise a second polyethylene film including a second polyethylene layer, wherein the plurality of gas-filled polyethylene bubbles are attached directly to the second polyethylene layer of the second polyethylene film. The second polyethylene film may be a second metallized polyethylene film including a second metallic layer and the second polyethylene layer. A second surface of the second metallic layer of the second metallized polyethylene film opposite to the second polyethylene layer of the second metallized polyethylene film may be exposed to an environment surrounding the system.

A method of fabricating a packaging material system may comprise: coupling a plurality of gas-filled polyethylene bubbles to a metallized polyethylene film including a metallic layer and the polyethylene layer, such that a surface of the metallic layer of the metallized polyethylene film opposite to the polyethylene layer of the metallized polyethylene film is exposed to an environment surrounding the system.

### BRIEF DESCRIPTION OF THE SEVERAL VIEWS OF THE DRAWINGS

FIG. 1 illustrates a plurality of layers of a packaging material system, according to at least one illustrated embodiment.

FIG. 2 illustrates the packaging material system of FIG. 1 in an assembled configuration.

FIG. 3 illustrates a plurality of layers of another packaging material system, according to at least one illustrated embodiment.

FIG. 4 illustrates the packaging material system of FIG. 3 in an assembled configuration.

FIG. 5 illustrates a plurality of layers of another packaging material system, according to at least one illustrated embodiment.

FIG. 6 illustrates the packaging material system of FIG. 5 in an assembled configuration.

FIG. 7 illustrates a plurality of layers of another packaging material system, according to at least one illustrated embodiment.

FIG. 8 illustrates the packaging material system of FIG. 7 in an assembled configuration.

FIG. 9 illustrates a package including the packaging material system of FIGS. 3 and 4, according to at least one illustrated embodiment.

FIG. 10 illustrates a flow chart diagram of a method of fabricating the packaging material system of FIGS. 1 and 2, according to at least one illustrated embodiment.

FIG. 11 illustrates a flow chart diagram of a method of fabricating the packaging material system of FIGS. 3 and 4, according to at least one illustrated embodiment.

FIG. 12 illustrates a flow chart diagram of a method of fabricating the packaging material system of FIGS. 5 and 6, according to at least one illustrated embodiment.

FIG. 13 illustrates a flow chart diagram of a method of fabricating the packaging material system of FIGS. 7 and 8, according to at least one illustrated embodiment.

FIG. 14 illustrates a flow chart diagram of a method of fabricating and using a package, according to at least one illustrated embodiment.

FIG. 15 illustrates the results of experimental tests run on a packaging material as described herein and several commercially available products.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The use of ordinals such as first, second and third does not necessarily imply a ranked sense of order, but rather may only distinguish between multiple instances of an act or structure.

Terms of geometric alignment are used herein. Any components of the embodiments that are illustrated, described, or claimed herein as being aligned, arranged in the same direction, parallel, or having other similar geometric relationships with respect to one another have such relationships in the illustrated, described, or claimed embodiments. In alternative embodiments, however, such components can have any of the other similar geometric properties described herein indicating alignment with respect to one another. Any components of the embodiments that are illustrated, described, or claimed herein as being not aligned, arranged in different directions, not parallel, perpendicular, transverse, or having other similar geometric relationships with respect to one another, have such relationships in the illustrated, described, or claimed embodiments. In alternative embodiments, however, such components can have any of the other similar geometric properties described herein indicating non-alignment with respect to one another.

Various examples of suitable dimensions of components may be provided herein. In the illustrated, described, and claimed embodiments, such dimensions are accurate to within standard manufacturing tolerances unless stated otherwise. Such dimensions are examples, however, and can be modified to produce variations of the components and systems described herein. For example, in various alternative embodiments, such dimensions can be approximations wherein the actual dimensions can vary by up to 1, 2, 5, 10, 15 or more percent from the stated, approximate dimensions.

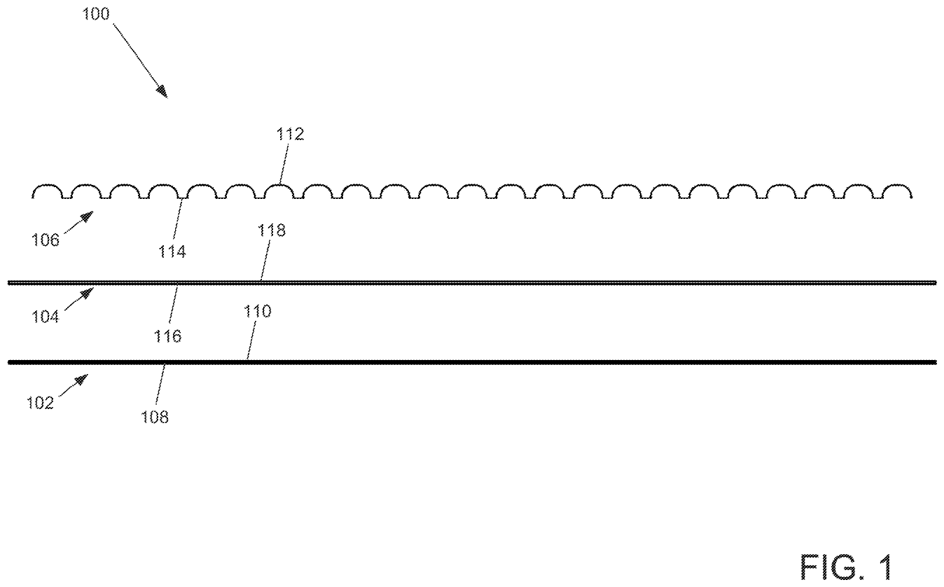

FIG. 1 illustrates a plurality of layers of a packaging material system 100 in an exploded or disassembled configuration. That is, FIG. 1 illustrates the layers of the packaging material system 100 in its final, assembled form with the layers separated from one another, rather than the layers of the packaging material system 100 prior to the assembly of the packaging material system 100. As illustrated in FIG. 1, the packaging material 100 includes a first layer, which can be a metallic layer 102, a second layer, which can be a polymeric layer 104, and a third layer, which can be a bubble layer 106 made of a polymeric material. The polymeric material of the bubble layer 106 and the polymeric material of the polymeric layer 104 can comprise the same polymeric material. In some cases, the packaging material 100 includes only the metallic layer 102, the polymeric layer 104, and the bubble layer 106, without any other layers or components coupled thereto.

As used herein, the term “layer” can refer to a single, integral, or monolithic sheet of a consistent or homogenous material or mixture of materials, arranged in a consistent, repeating, or patterned structure. The packaging materials and the layers described herein can each have a first major axis and a second major axis perpendicular to the first major axis, and a minor axis perpendicular to the first and second major axes, wherein the material's or the layer's dimensions along the first and second major axes are much larger than the material's or the layer's dimension along the minor axis.

The metallic layer 102 has a first, exposed, outer surface 108 and a second, inner surface 110 opposite to the outer surface 108. The bubble layer 106 has a first, exposed, outer surface 112 and a second, inner surface 114 opposite to the outer surface 112. The polymeric layer 104 has a first surface 116 that faces the metallic layer 102 and a second surface 118 that faces the bubble layer 106, which is opposite to the first surface 116.

As used herein, a “surface” of a layer can refer to a major surface of the layer that spans across an outer periphery of the layer along the first and second major axes of the layer and perpendicular to the minor axis of the layer. The surfaces of layers of materials described herein can be exposed, outer, or external surfaces, meaning that they are exposed, along the minor axis of the packaging material, to an external environment surrounding the piece of material of which the layer forms a part when the material is in its assembled configuration. As used herein, an “environment” of a material can refer to the matter and conditions external to and surrounding the material, and does not include any components of the material itself. The surfaces of layers of materials described herein can also be covered, inner, or internal surfaces, meaning that they are in direct contact with and covered, along the minor axis of the packaging material, by another layer or other component of the piece of material of which the layer forms a part when the material is in its assembled configuration.

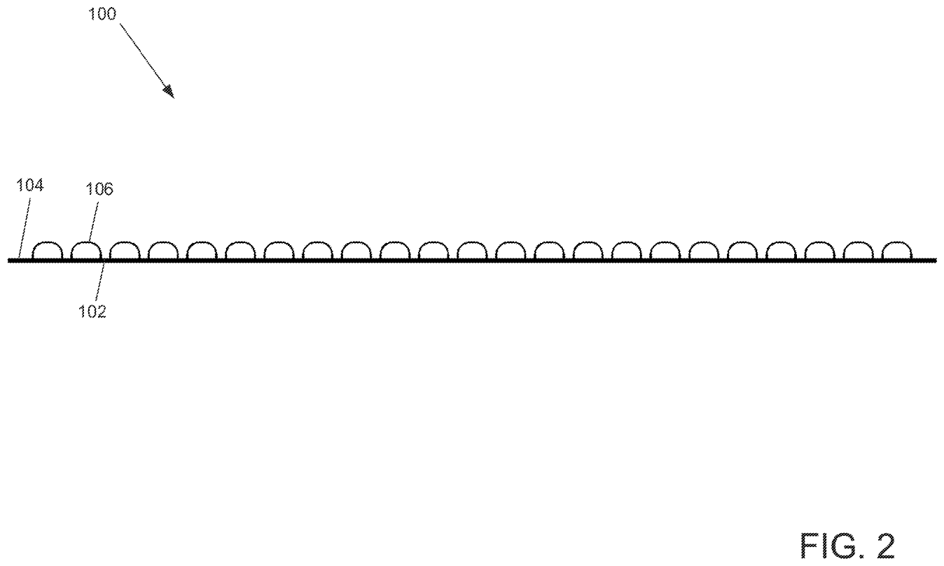

FIG. 2 illustrates the packaging material 100 and its various layers in an assembled configuration. As illustrated in FIGS. 1 and 2, when the layers of the packaging material 100 are assembled, the outer surface 108 of the metallic layer 102 is exposed to an environment surrounding the material 100. The inner surface 110 of the metallic layer 102 is engaged with, directly coupled to, and can be co-extensive with (e.g., have the same dimensions and the same positions along its first and second major axes as), the first surface 116 of the polymeric layer 104, such that the inner surface 110 of the metallic layer 102 and the first surface 116 of the polymeric layer 104 can completely cover each other so that neither is exposed to the environment surrounding the material 100 along the minor axis of the packaging material 100.

The inner surface 114 of the bubble layer 106 is engaged with, directly coupled to, and can be co-extensive with the second surface 118 of the polymeric layer 104, such that the inner surface 114 of the bubble layer 106 and the second surface 118 of the polymeric layer 104 can completely cover each other so that neither is exposed to the environment surrounding the material 100 along the minor axis of the packaging material 100. The outer surface 112 of the bubble layer 106 is exposed to the environment surrounding the material 100. Thus, when the layers of the material 100 are assembled, the material 100 has exactly two exposed major surfaces, including the outer surface 108 of the metallic layer 102 and the outer surface 112 of the bubble layer 106, which are exposed to the environment surrounding the material 100.

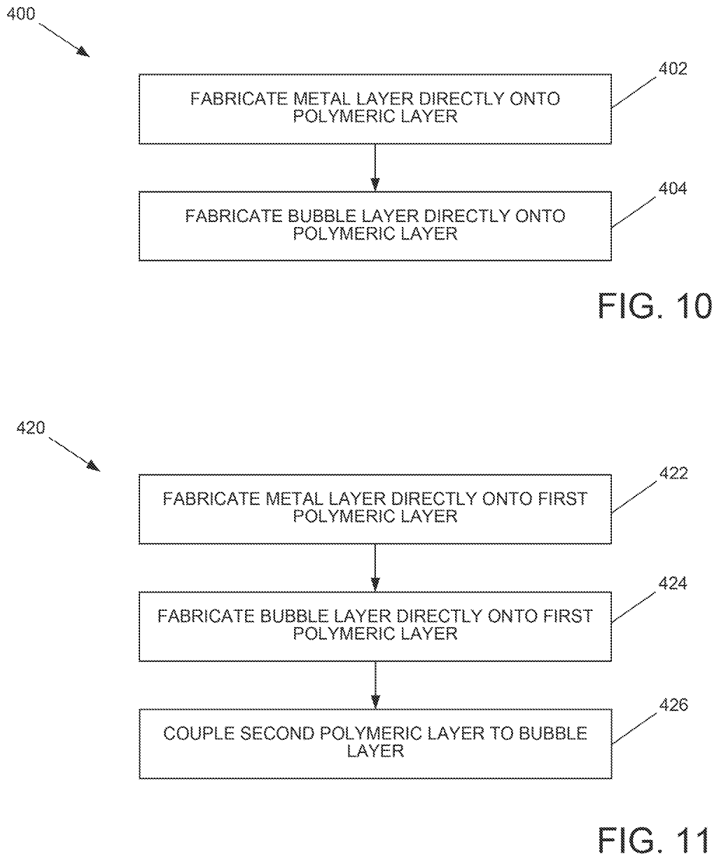

FIG. 10 illustrates a method 400 of forming the packaging material 100. As shown in FIG. 10, the method 400 includes fabricating the metallic layer 102 directly onto the first surface 116 of the polymeric layer 104, such as through any suitable metallizing process, at 402. The method 400 also includes fabricating the bubble layer 106 directly onto the second surface 118 of the polymeric layer 104, such as through any suitable process for forming cellular cushioning materials, which can be referred to colloquially as “bubble wrap,” at 404. In some cases, such a process of fabricating the bubble layer 106 can include starting with a flat or planar polymeric film and forming the bubbles of the bubble layer 106 as the bubble layer 106 is coupled to the polymeric layer 104. As the term is used herein, it is understood that the “bubbles” of the bubble layer 106 refer to the dome-shaped portions of the bubble layer 106 that do not by themselves form completely enclosed bubbles, but form a substantial portion of completely enclosed bubbles in the final product. In such cases, the bubble layer 106 as it is illustrated in FIG. 1 represents the bubble layer 106 after such a process has occurred.

In some implementations, the metallic layer 102 can be fabricated directly onto the first surface 116 of the polymeric layer 104 to form a dual-layer metallized polymer film at 402 before the bubble layer 106 is fabricated directly onto the second surface 118 of the polymeric layer 104 at 404. In other implementations, the metallic layer 102 can be fabricated directly onto the first surface 116 of the polymeric layer 104 at 404 after the bubble layer 106 is fabricated directly onto the second surface 118 of the polymeric layer 104 at 402.

Once fabricated according to the method 400, as described above, the packaging material 100 forms a metallized cellular cushioning material. The cellular cushioning material has a plurality of spaced apart air-filled or other gas-filled hemispherical or dome-shaped bubbles formed from the bubble layer 106 that protrude outward away from the flat or planar polymeric layer 104. The bubbles of the cellular cushioning material can be spaced apart from one another in a regular pattern, such as in a triangular, square, or hexagonal tiling pattern, or in an irregular pattern. The bubbles of the cellular cushioning material can have various shapes when viewed from above (e.g., along a minor axis of the cellular cushioning material), such as circular, hexagonal, square, or triangular shapes, and can have any suitable size, such as a diameter or maximum width, when viewed from above, of around 1.0 cm.

The metallic layer 102 can comprise any suitable metallic material, including aluminum, nickel, or chromium. The polymeric layer 104 can comprise any suitable polymeric material, including polyester, polypropylene, or polyethylene terephthalate. The bubble layer 106 can also comprise any suitable polymeric material, including polyester, polypropylene, or polyethylene terephthalate, and can comprise the same polymeric material as the polymeric layer 104. In some specific implementations, the metallic layer 102 can comprise an aluminum material and the polymeric layer 104 and the bubble layer 106 can each comprise a polyethylene material, such as a high-density polyethylene and linear low-density polyethylene co-extrusion.

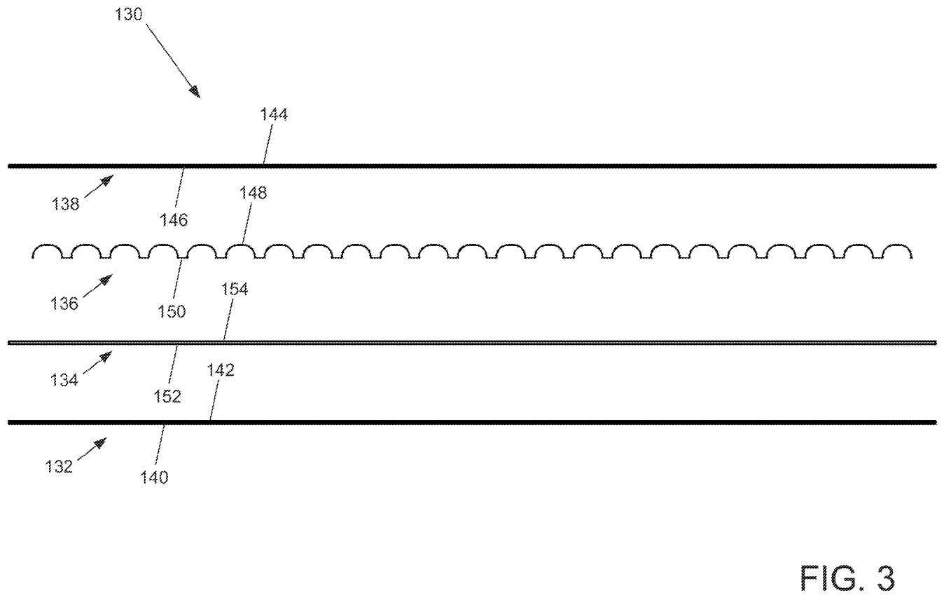

FIG. 3 illustrates a plurality of layers of a packaging material system 130 in an exploded or disassembled configuration. As illustrated in FIG. 3, the packaging material 130 includes a first layer, which can be a metallic layer 132, a second layer, which can be a polymeric layer 134, a third layer, which can be a bubble layer 136 made of a polymeric material, and a fourth layer, which can be a polymeric layer 138. The polymeric material of the bubble layer 136 and the polymeric materials of the polymeric layers 134 and 138 can comprise the same polymeric material. In some cases, the packaging material 130 includes only the metallic layer 132, the polymeric layer 134, the bubble layer 136, and the polymeric layer 138, without any other layers or components coupled thereto.

The metallic layer 132 has a first, exposed, outer surface 140 and a second, inner surface 142 opposite to the outer surface 140. The polymeric layer 138 has a first, exposed, outer surface 144 and a second, inner surface 146 opposite to the outer surface 144. The bubble layer 136 has a first surface 148 that faces the polymeric layer 138 and a second surface 150 that faces the polymeric layer 134, which is opposite to the first surface 148. The polymeric layer 134 has a first surface 152 that faces the metallic layer 132 and a second surface 154 that faces the bubble layer 136, which is opposite to the first surface 152.

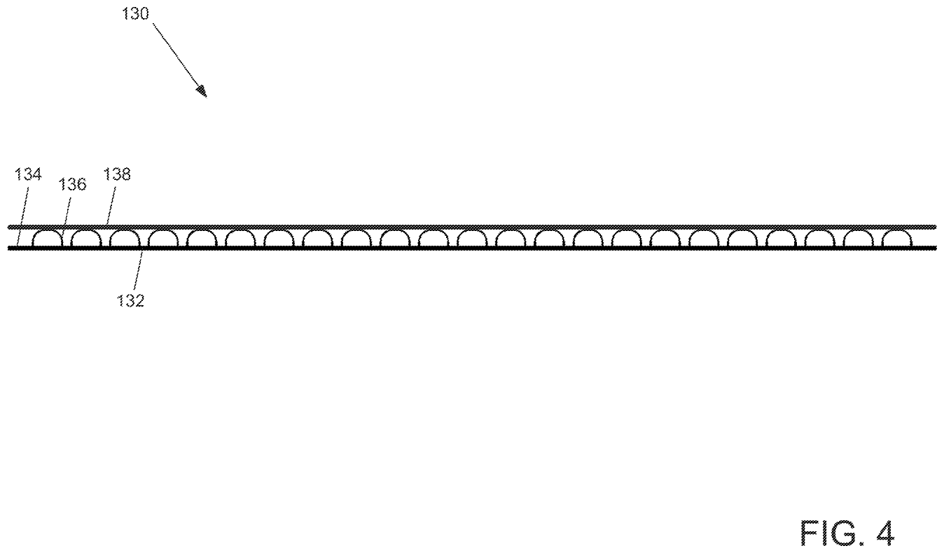

FIG. 4 illustrates the packaging material 130 and its various layers in an assembled configuration. As illustrated in FIGS. 3 and 4, when the layers of the packaging material 130 are assembled, the outer surface 140 of the metallic layer 132 is exposed to an environment surrounding the material 130. The inner surface 142 of the metallic layer 132 is engaged with, directly coupled to, and can be co-extensive with, the first surface 152 of the polymeric layer 134, such that the inner surface 142 of the metallic layer 132 and the first surface 152 of the polymeric layer 134 can completely cover each other so that neither is exposed to the environment surrounding the material 130 along the minor axis of the packaging material 130.

The outer surface 144 of the polymeric layer 138 is exposed to the environment surrounding the material 130. The inner surface 146 of the polymeric layer 138 is engaged with, directly coupled to, and can be co-extensive with, the first surface 148 of the bubble layer 136, such that the inner surface 146 of the polymeric layer 138 and the first surface 148 of the bubble layer 136 can completely cover each other so that neither is exposed to the environment surrounding the material 130 along the minor axis of the packaging material 130. The second surface 150 of the bubble layer 136 is engaged with, directly coupled to, and can be co-extensive with, the second surface 154 of the polymeric layer 134, such that the second surface 150 of the bubble layer 136 and the second surface 154 of the polymeric layer 134 can completely cover each other so that neither is exposed to the environment surrounding the material 130 along the minor axis of the packaging material 130. Thus, when the layers of the material 130 are assembled, the material 130 has exactly two exposed major surfaces, including the outer surface 140 of the metallic layer 132 and the outer surface 144 of the polymeric layer 138, which are exposed to the environment surrounding the material 130.

FIG. 11 illustrates a method 420 of forming the packaging material 130. As shown in FIG. 11, the method 420 includes fabricating the metallic layer 132 directly onto the first surface 152 of the polymeric layer 134, such as through any suitable metallizing process, at 422. The method 420 also includes fabricating the bubble layer 136 directly onto the second surface 154 of the polymeric layer 134, such as through any suitable process for forming cellular cushioning materials, at 424. In some cases, such a process of fabricating the bubble layer 136 can include starting with a flat or planar polymeric film and forming the bubbles of the bubble layer 136 as the bubble layer 136 is coupled to the polymeric layer 134. In such cases, the bubble layer 136 as it is illustrated in FIG. 3 represents the bubble layer 136 after such a process has occurred.

The metallic layer 132 can be fabricated directly onto the first surface 152 of the polymeric layer 134 at 402 either before or after the bubble layer 136 is fabricated directly onto the second surface 154 of the polymeric layer 134 at 404. The method 420 also includes coupling the polymeric layer 138 to the first surface 148 of the bubble layer 136, such as by using a heat gun or other source of heat to melt the respective materials and weld them together, at 426.

Once fabricated according to the method 420, as described above, the packaging material 130 forms a metallized cellular cushioning material. The cellular cushioning material has a plurality of spaced apart air-filled or other gas-filled hemispherical or dome-shaped bubbles formed from the bubble layer 136 that protrude outward away from the flat or planar polymeric layer 134. The bubbles of the cellular cushioning material can be spaced apart from one another in a regular pattern, such as in a triangular, square, or hexagonal tiling pattern, or in an irregular pattern. The bubbles of the cellular cushioning material can have various shapes when viewed from above (e.g., along a minor axis of the cellular cushioning material), such as circular, hexagonal, square, or triangular shapes, and can have any suitable size, such as a diameter or maximum width, when viewed from above, of around 1.0 cm.

The resulting packaging material 130 can have the same overall structure as the packaging material 100 except that the packaging material 130 has the additional polymeric layer 138. The addition of the polymeric layer 138 to the material 100 can be advantageous because it provides the material 130 with a smooth outer surface 144, across which other objects can more easily and smoothly slide, such as when a user is inserting a good into a package made from the material 130.

The metallic layer 132 can comprise any suitable metallic material, including aluminum, nickel, or chromium. The polymeric layers 134 and 138, and the bubble layer 136 can comprise any suitable polymeric material, including polyester, polypropylene, or polyethylene terephthalate. In some specific implementations, the metallic layer 132 can comprise an aluminum material and the polymeric layers 134 and 138, and the bubble layer 136 can each comprise a polyethylene material, such as a high-density polyethylene and linear low-density polyethylene co-extrusion.

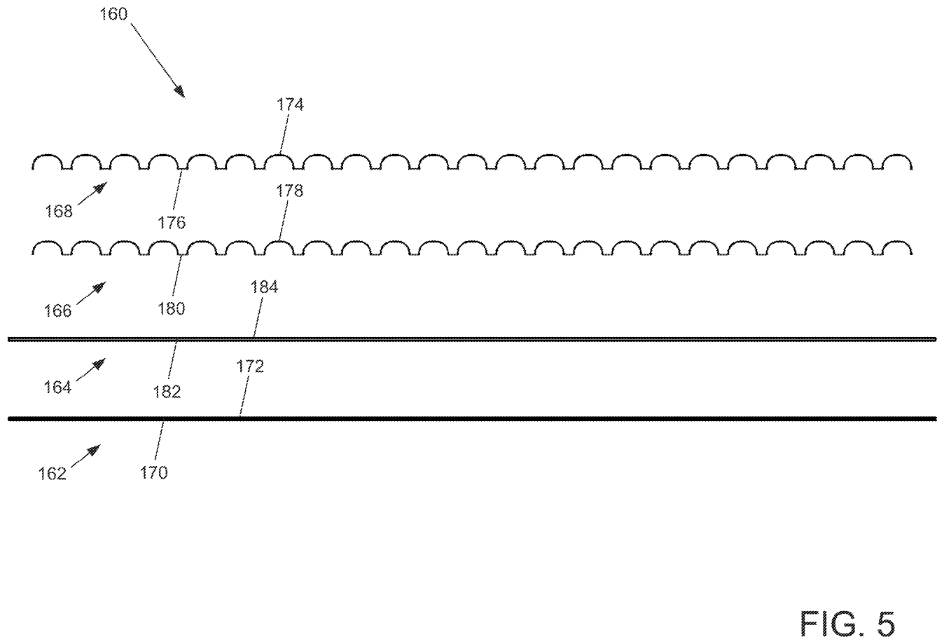

FIG. 5 illustrates a plurality of layers of a packaging material system 160 in an exploded or disassembled configuration. As illustrated in FIG. 5, the packaging material 160 includes a first layer, which can be a metallic layer 162, a second layer, which can be a polymeric layer 164, a third layer, which can be a bubble layer 166 made of a polymeric material, and a fourth layer, which can be a metallic layer 168. The polymeric material of the bubble layer 166 and the polymeric material of the polymeric layer 164 can comprise the same polymeric material and the metallic materials of the metallic layers 162 and 168 can comprise the same metallic material. In some cases, the packaging material 160 includes only the metallic layer 162, the polymeric layer 164, the bubble layer 166, and the metallic layer 168, without any other layers or components coupled thereto.

The metallic layer 162 has a first, exposed, outer surface 170 and a second, inner surface 172 opposite to the outer surface 170. The metallic layer 168 has a first, exposed, outer surface 174 and a second, inner surface 176 opposite to the outer surface 174. The bubble layer 166 has a first surface 178 that faces the metallic layer 168 and a second surface 180 that faces the polymeric layer 164, which is opposite to the first surface 178. The polymeric layer 164 has a first surface 182 that faces the metallic layer 162 and a second surface 184 that faces the bubble layer 166, which is opposite to the first surface 182.

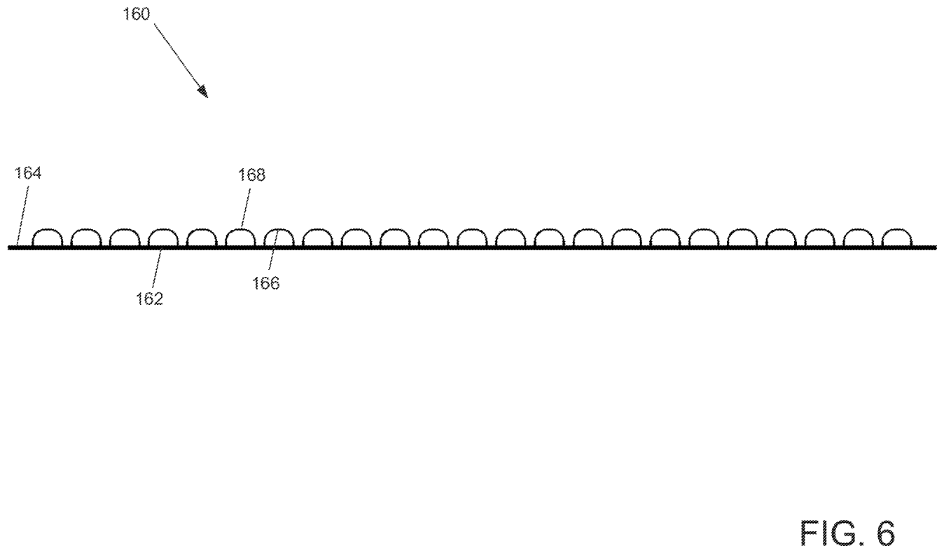

FIG. 6 illustrates the packaging material 160 and its various layers in an assembled configuration. As illustrated in FIGS. 5 and 6, when the layers of the packaging material 160 are assembled, the outer surface 170 of the metallic layer 162 is exposed to an environment surrounding the material 160. The inner surface 172 of the metallic layer 162 is engaged with, directly coupled to, and can be co-extensive with, the first surface 182 of the polymeric layer 164, such that the inner surface 172 of the metallic layer 162 and the first surface 182 of the polymeric layer 164 can completely cover each other so that neither is exposed to the environment surrounding the material 160 along the minor axis of the packaging material 160.

The outer surface 174 of the metallic layer 168 is exposed to the environment surrounding the material 160. The inner surface 176 of the metallic layer 168 is engaged with, directly coupled to, and can be co-extensive with, the first surface 178 of the bubble layer 166, such that the inner surface 176 of the metallic layer 168 and the first surface 178 of the bubble layer 166 can completely cover each other so that neither is exposed to the environment surrounding the material 160 along the minor axis of the packaging material 160. The second surface 180 of the bubble layer 166 is engaged with, directly coupled to, and can be co-extensive with, the second surface 184 of the polymeric layer 164, such that the second surface 180 of the bubble layer 166 and the second surface 184 of the polymeric layer 164 can completely cover each other so that neither is exposed to the environment surrounding the material 160 along the minor axis of the packaging material 160. Thus, when the layers of the material 160 are assembled, the material 160 has exactly two exposed major surfaces, including the outer surface 170 of the metallic layer 162 and the outer surface 174 of the metallic layer 168, which are exposed to the environment surrounding the material 160.

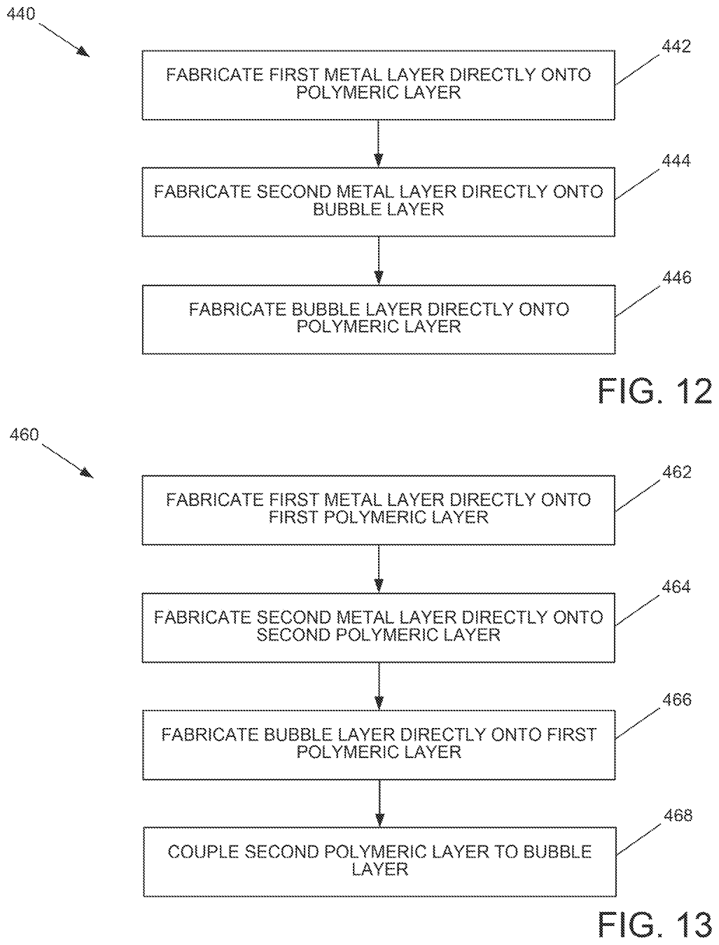

FIG. 12 illustrates a method 440 of forming the packaging material 160. As shown in FIG. 12, the method 440 includes fabricating the metallic layer 162 directly onto the first surface 182 of the polymeric layer 164, at 442, and the metallic layer 168 directly onto the first surface 178 of the bubble layer 166, at 444, such as through any suitable metallizing processes. The method 440 also includes fabricating the bubble layer 166 directly onto the second surface 184 of the polymeric layer 164, such as through any suitable process for forming cellular cushioning materials, at 446. In some cases, such a process of fabricating the bubble layer 166 can include starting with a flat or planar polymeric film and forming the bubbles of the bubble layer 166 as the bubble layer 166 is coupled to the polymeric layer 164. In such cases, the bubble layer 166 and the metallic layer 168 as they are illustrated in FIG. 5 represent the bubble layer 166 and the metallic layer 168 after such a process has occurred.

In some implementations, the metallic layer 162 can be fabricated directly onto the first surface 182 of the polymeric layer 164 to form a dual-layer metallized polymer film at 442 and the metallic layer 168 can be fabricated directly onto the first surface 178 of the bubble layer 166 to form a dual-layer metallized bubble film at 444 before the bubble layer 166 is fabricated directly onto the second surface 184 of the polymeric layer 164 at 446. In other implementations, the metallic layer 162 can be fabricated directly onto the first surface 182 of the polymeric layer 164 at 442 and/or the metallic layer 168 can be fabricated directly onto the first surface 178 of the bubble layer 166 at 444 after the bubble layer 166 is fabricated directly onto the second surface 184 of the polymeric layer 164 at 446.

Once fabricated according to the method 440, as described above, the packaging material 160 forms a metallized cellular cushioning material. The cellular cushioning material has a plurality of spaced apart air-filled or other gas-filled hemispherical or dome-shaped bubbles formed from the bubble layer 166 that protrude outward away from the flat or planar polymeric layer 164. The bubbles of the cellular cushioning material can be spaced apart from one another in a regular pattern, such as in a triangular, square, or hexagonal tiling pattern, or in an irregular pattern. The bubbles of the cellular cushioning material can have various shapes when viewed from above (e.g., along a minor axis of the cellular cushioning material), such as circular, hexagonal, square, or triangular shapes, and can have any suitable size, such as a diameter or maximum width, when viewed from above, of around 1.0 cm.

The resulting packaging material 160 can have the same overall structure as the packaging material 100 except that the packaging material 160 has the additional metallic layer 168. The addition of the metallic layer 168 to the material 100 can be advantageous because it provides the material 160 with improved heat transfer properties. Specifically, adding the metallic layer 168 can reduce the thermal conductivity of the packaging material 160 relative to the packaging material 100, so that goods stored within a package made from the packaging material 160 can remain colder for longer or hotter for longer, depending on the application.

The metallic layer 162 and the metallic layer 168 can comprise any suitable metallic material, including aluminum, nickel, or chromium. The polymeric layer 164 and the bubble layer 166 can comprise any suitable polymeric material, including polyester, polypropylene, or polyethylene terephthalate. In some specific implementations, the metallic layer 162 and the metallic layer 168 can comprise an aluminum material and the polymeric layer 164 and the bubble layer 166 can each comprise a polyethylene material, such as a high-density polyethylene and linear low-density polyethylene co-extrusion.

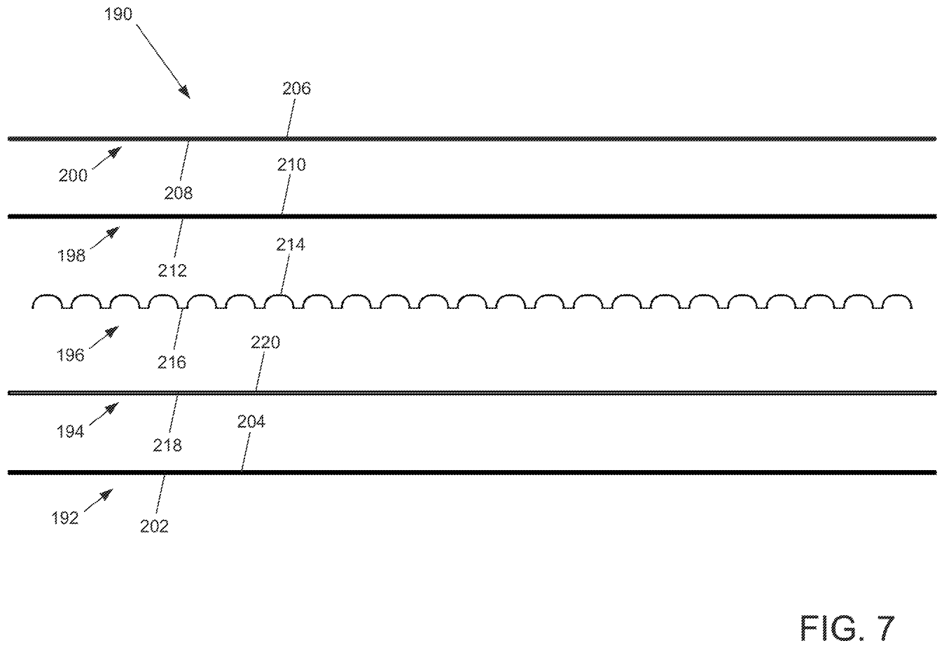

FIG. 7 illustrates a plurality of layers of a packaging material system 190 in an exploded or disassembled configuration. As illustrated in FIG. 7, the packaging material 190 includes a first layer, which can be a metallic layer 192, a second layer, which can be a polymeric layer 194, a third layer, which can be a bubble layer 196 made of a polymeric material, a fourth layer, which can be a polymeric layer 198, and a fifth layer, which can be a metallic layer 200. The polymeric material of the bubble layer 196 and the polymeric materials of the polymeric layers 194 and 198 can comprise the same polymeric material and the metallic materials of the metallic layers 192 and 200 can comprise the same metallic material. In some cases, the packaging material 190 includes only the metallic layer 192, the polymeric layer 194, the bubble layer 196, the polymeric layer 198, and the metallic layer 200, without any other layers or components coupled thereto.

The metallic layer 192 has a first, exposed, outer surface 202 and a second, inner surface 204 opposite to the outer surface 202. The metallic layer 200 has a first, exposed, outer surface 206 and a second, inner surface 208 opposite to the outer surface 206. The polymeric layer 198 has a first surface 210 that faces the metallic layer 200 and a second surface 212 that faces the bubble layer 196, which is opposite to the first surface 210. The bubble layer 196 has a first surface 214 that faces the polymeric layer 198 and a second surface 216 that faces the polymeric layer 194, which is opposite to the first surface 214. The polymeric layer 194 has a first surface 218 that faces the metallic layer 192 and a second surface 220 that faces the bubble layer 196, which is opposite to the first surface 218.

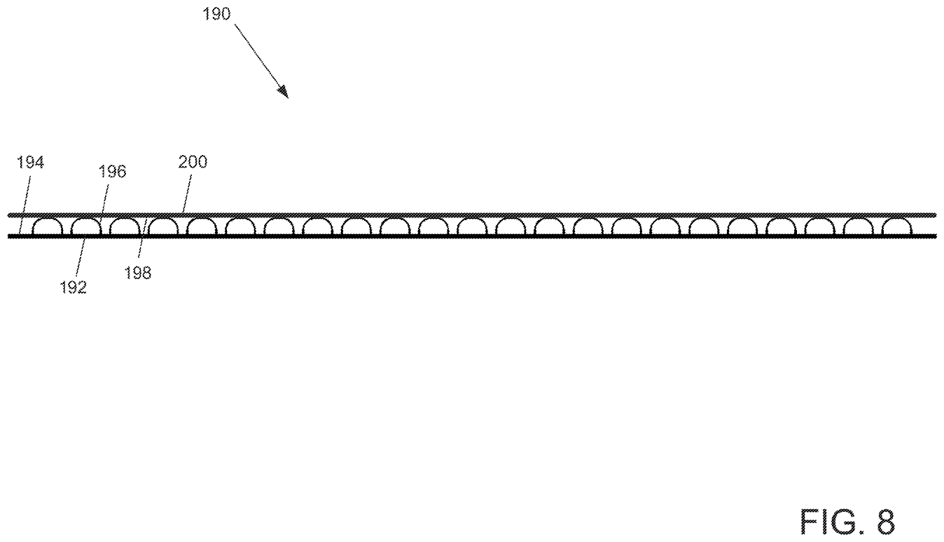

FIG. 8 illustrates the packaging material 190 and its various layers in an assembled configuration. As illustrated in FIGS. 7 and 8, when the layers of the packaging material 190 are assembled, the outer surface 202 of the metallic layer 192 is exposed to an environment surrounding the material 190. The inner surface 204 of the metallic layer 192 is engaged with, directly coupled to, and can be co-extensive with, the first surface 218 of the polymeric layer 194, such that the inner surface 204 of the metallic layer 192 and the first surface 218 of the polymeric layer 194 can completely cover each other so that neither is exposed to the environment surrounding the material 190 along the minor axis of the packaging material 190. Similarly, the outer surface 206 of the metallic layer 200 is exposed to the environment surrounding the material 190. The inner surface 208 of the metallic layer 200 is engaged with, directly coupled to, and can be co-extensive with, the first surface 210 of the polymeric layer 198, such that the inner surface 208 of the metallic layer 200 and the first surface 210 of the polymeric layer 198 can completely cover each other so that neither is exposed to the environment surrounding the material 190 along the minor axis of the packaging material 190.

The second surface 212 of the polymeric layer 198 is engaged with, directly coupled to, and can be co-extensive with, the first surface 214 of the bubble layer 196, such that the second surface 212 of the polymeric layer 198 and the first surface 214 of the bubble layer 196 can completely cover each other so that neither is exposed to the environment surrounding the material 190 along the minor axis of the packaging material 190. The second surface 216 of the bubble layer 196 is engaged with, directly coupled to, and can be co-extensive with, the second surface 220 of the polymeric layer 194, such that the second surface 216 of the bubble layer 196 and the second surface 220 of the polymeric layer 194 can completely cover each other so that neither is exposed to the environment surrounding the material 190 along the minor axis of the packaging material 190. Thus, when the layers of the material 190 are assembled, the material 190 has exactly two exposed major surfaces, including the outer surface 202 of the metallic layer 192 and the outer surface 206 of the metallic layer 200, which are exposed to the environment surrounding the material 190.

FIG. 13 illustrates a method 460 of forming the packaging material 190. As shown in FIG. 13, the method 460 includes fabricating the metallic layer 192 directly onto the first surface 218 of the polymeric layer 194, at 462, and fabricating the metallic layer 200 directly onto the first surface 210 of the polymeric layer 198, at 464, such as through any suitable metallizing processes. The method 460 also includes fabricating the bubble layer 196 directly onto the second surface 220 of the polymeric layer 194, such as through any suitable process for forming cellular cushioning materials, at 466. In some cases, such a process of fabricating the bubble layer 196 can include starting with a flat or planar polymeric film and forming the bubbles of the bubble layer 196 as the bubble layer 196 is coupled to the polymeric layer 194. In such cases, the bubble layer 196 as it is illustrated in FIG. 7 represents the bubble layer 196 after such a process has occurred.

The method 460 also includes coupling the polymeric layer 198 to the first surface 214 of the bubble layer 196 through any suitable process for coupling two polymeric layers together, such as by using a heat gun or other source of heat to melt the respective materials and weld them together, at 468. In some implementations, the metallic layer 192 can be fabricated directly onto the polymeric layer 194 to form a dual-layer metallized polymer film at 462 and the metallic layer 200 can be fabricated directly onto the polymeric layer 198 to form a dual-layer metallized bubble film at 464 before the bubble layer 196 is fabricated directly onto the polymeric layer 194 at 466 and before the polymeric layer 198 is coupled to the bubble layer 196 at 468. In other implementations, the metallic layer 192 can be fabricated directly onto the polymeric layer 194 at 462 and/or the metallic layer 200 can be fabricated directly onto the polymeric layer 198 at 464 after the bubble layer 196 is fabricated directly onto the polymeric layer 164 at 466 and/or after the polymeric layer 198 is coupled to the bubble layer 196 at 468.

Once fabricated according to the method 460, as described above, the packaging material 190 forms a metallized cellular cushioning material. The cellular cushioning material has a plurality of spaced apart air-filled or other gas-filled hemispherical or dome-shaped bubbles formed from the bubble layer 196 that protrude outward away from the flat or planar polymeric layer 194. The bubbles of the cellular cushioning material can be spaced apart from one another in a regular pattern, such as in a triangular, square, or hexagonal tiling pattern, or in an irregular pattern. The bubbles of the cellular cushioning material can have various shapes when viewed from above (e.g., along a minor axis of the cellular cushioning material), such as circular, hexagonal, square, or triangular shapes, and can have any suitable size, such as a diameter or maximum width, when viewed from above, of around 1.0 cm.

The resulting packaging material 190 can have the same overall structure as the packaging material 100 except that the packaging material 190 has the additional polymeric layer 198 and the additional metallic layer 200. The addition of the polymeric layer 198 and the metallic layer 200 to the material 100 can be advantageous for the reasons set forth above for the packaging material 130 and the packaging material 160, namely, because they provide the material 190 with a smooth outer surface 206, across which other objects can more easily and smoothly slide, such as when a user is inserting a good into a package made from the material 190, and because they provide the material 190 with improved heat transfer properties. Specifically, adding the metallic layer 200 can reduce the thermal conductivity of the packaging material 190 relative to the packaging material 100, so that goods stored within a package made from the packaging material 190 can remain colder for longer or hotter for longer, depending on the application.

The metallic layer 192 and the metallic layer 200 can comprise any suitable metallic material, including aluminum, nickel, or chromium. The polymeric layer 194, the bubble layer 196, and the polymeric layer 198 can comprise any suitable polymeric material, including polyester, polypropylene, or polyethylene terephthalate. In some specific implementations, the metallic layers 192 and 200 can comprise an aluminum material and the polymeric and bubble layers 194, 196, and 198 can each comprise a polyethylene material, such as a high-density polyethylene and linear low-density polyethylene co-extrusion.

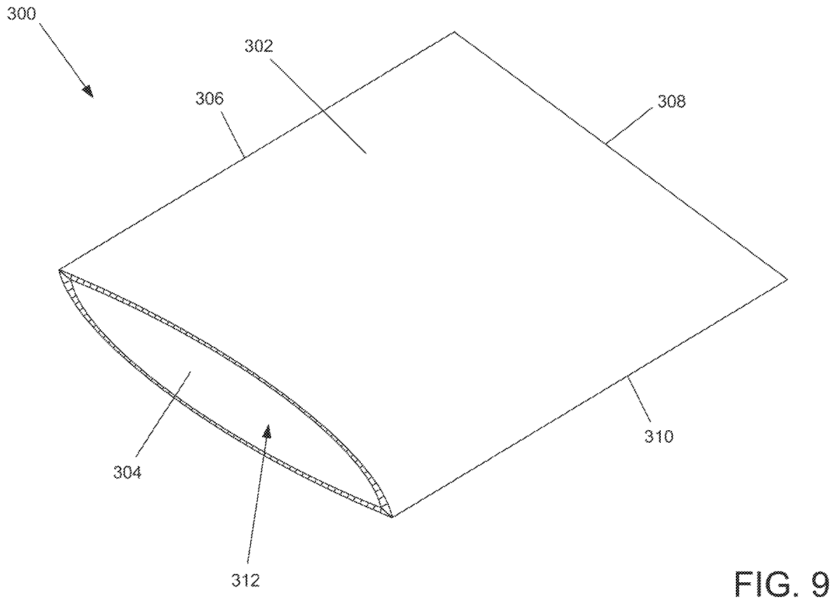

FIG. 9 illustrates a package 300 including a first sheet of packaging material 302 coupled to a second sheet of packaging material 304. The first and second sheets of packaging material 302 and 304 each comprise the packaging material 130, but in alternative implementations, the first and second sheets of packaging material 302 and 304 can each comprise the packaging material 100, the packaging material 160, and/or the packaging material 190. The packaging material 100 and the packaging material 130 can be preferred for use in the package 300 because they have exposed polymeric layers (specifically, polyethylene layers) that can be easily bonded to one another. Nevertheless, the packaging material 160 or packaging material 190 could be used in the package 300, such as by applying an additional polymeric (e.g., polyethylene) layer over one of their exposed metallic layers.

As illustrated in FIG. 9, the package 300 is rectangular and includes three edges 306, 308, and 310, at which the first and the second sheets of packaging material 302 and 304 are coupled to one another to form a pouch, and a fourth edge at which the first and second sheets of packaging material 302 and 304 are not coupled to one another to form a mouth 312 of the package 300. When first and second sheets of packaging material 302 and 304 comprise the same packaging material, coupling of the first and second sheets along one of the three edges 306, 308 and 310 can be achieved by folding the sheet of packaging material over on itself. In some implementations, the first and second sheets of packaging material 302 and 304 are arranged so that the respective metallic layers 132 of the sheets 302 and 304 are positioned on external surfaces of the package 300, while in other implementations, the first and second sheets of packaging material 302 and 304 are arranged so that the respective metallic layers 132 of the sheets 302 and 304 are positioned on internal surfaces of the package 300.

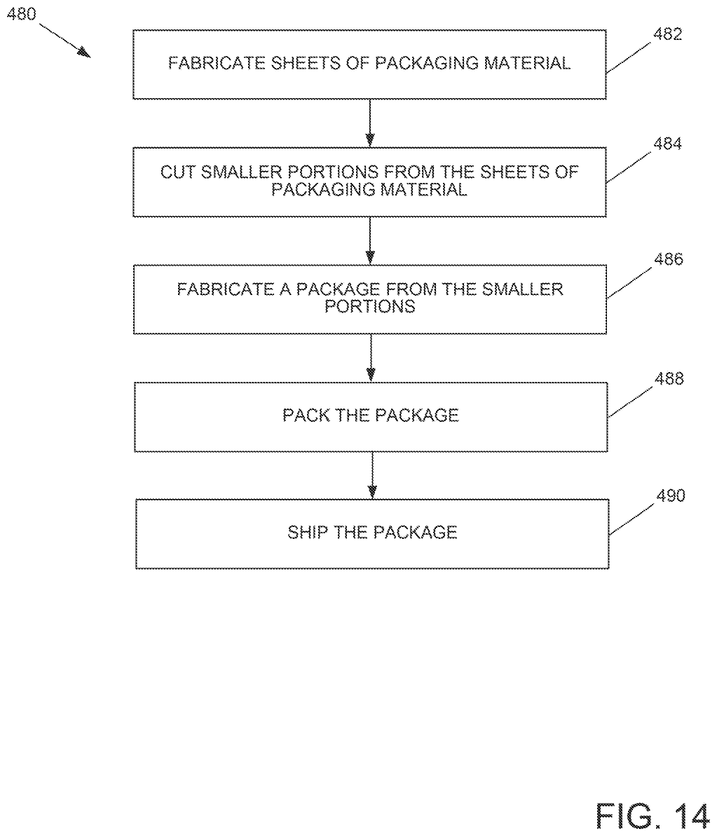

FIG. 14 illustrates a method 480 of fabricating and using a package with one or more of the packaging materials described herein. The method 480 includes fabricating one or more sheets of one or more of the packaging materials described herein, such as the packaging material 100, packaging material 130, packaging material 160, or the packaging material 190, at 482, and cutting smaller portions of packaging material from the one or more sheets of packaging material, at 484. The method 480 also includes using the smaller portions of the packaging material to fabricate a package, such as the package 300, at 486. The method 480 also includes packing the package with goods to be delivered, such as food items such as a meal kit, at 488, and then shipping the package and the goods packed therein to a recipient, which can be a customer, at 490.

Because the packaging materials described herein can be used to package food items, it can be important that the packaging materials have relatively low thermal conductivity, for example, such that hot food items stay hotter for longer, or such that cold food items stay colder for longer. Thus, the packaging materials described herein include both a bubble layer, which can form an air gap to reduce thermal conductivity through the packaging material, and a metallic layer, which can form a barrier to reduce O₂, H₂O, and light transmission through the packaging material, and which can reduce radiative and convective heat transfer through the packaging material.

Further, the packaging materials described herein can include exactly one metallic material and exactly one polymeric material, or only aluminum and only polyethylene, with the entirety of the aluminum having been metallized onto the polyethylene. Further, the packaging materials described herein can include no polyester, no polypropylene, and/or no polyethylene terephthalate. Such embodiments can make fabrication of the packaging materials described herein more efficient, such as by facilitating the bonding of the various layers made of polymeric materials to one another due to the compatibility of the polymeric materials of the various polymeric layers.

Such embodiments can also make disposal of the packaging materials described herein more efficient, such as by facilitating the recycling of the packaging materials due to the compatibility of the polymeric materials of the various polymeric layers, thereby reducing overall material waste. For example, the systems described herein can be melted down and used as the raw material in new systems of the same materials, without the need to separate different polymeric materials or different metallic materials from one another. The relatively small amount of aluminum incorporated into the systems described herein can leave a second generation system with a slight silver tint, but in no way impedes the straightforward melting down and reuse of the systems as raw input materials.

In addition to their use in packaging materials, the materials and systems described herein can be used in a variety of other insulating applications. For example, the systems described herein can be used as insulation in residential, commercial, or industrial structures, such as homes, warehouses, or factories.

The combinations of features of the embodiments described herein are counter-intuitive because metallized polyethylene can be more expensive, less resilient, and more difficult to work with than other metallized polymer films. For example, the metallic layer of metallized polyethylene films generally degrades, such as from handling or contact with other items, or from exposure to various environmental conditions and/or oxidation, more quickly that the metallic layer of other metallized polymer films, in some cases because the metallic layer of other metallized polymer films is covered on both surfaces by a polymeric layer.

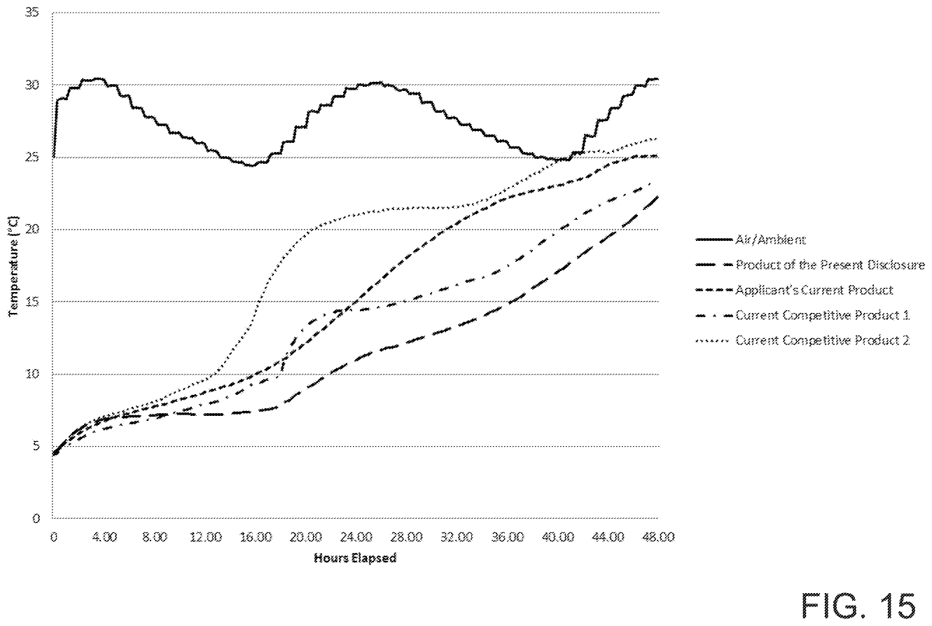

FIG. 15 illustrates the results of experimental tests run on a package corresponding to package 300 and several commercially available products, including one product commercially available from the Applicant. In these experimental tests, the various products were tested under the same, standardized conditions. The products were filled with a test sample and cooled to an initial temperature. They were then exposed to a warmer, ambient temperature that varied over the course of 48 hours, and the temperature of the test sample within the products was measured over the 48 hour duration of the test. The results illustrated in FIG. 15 clearly establish that the packaging material systems described herein perform significantly better than the tested commercially available products. It is believed that at least part of this improvement is attributable to the systems of the present disclosure including a metallic layer having an exposed surface, which increases reflectivity of the metallic layer relative to metallic layers that are covered on both surfaces by a polymeric layer.

U.S. provisional patent application No. 62/625,027, filed on Feb. 1, 2018, to which this application claims priority, is hereby incorporated herein by reference in its entirety. The various embodiments described above can be combined and/or rearranged (e.g., the order of actions of methods described herein can be rearranged into any suitable order) to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a metallized polyethylene film including a metallic layer and a polyethylene layer; and
a plurality of gas-filled polyethylene bubbles coupled to the metallized polyethylene film;
wherein a surface of the metallic layer of the metallized polyethylene film opposite to the polyethylene layer of the metallized polyethylene film is exposed to an environment surrounding the system.

2. The system of claim 1 wherein the metallic layer comprises aluminum.

3. The system of claim 1 wherein the system is recyclable.

4. The system of claim 1 wherein the system is thermally insulating.

5. The system of claim 1 wherein the system is a package.

6. The system of claim 5 wherein the package encloses food.

7. The system of claim 1 wherein the system is a barrier to O₂.

8. The system of claim 1 wherein the system is a barrier to H₂O.

9. The system of claim 1 wherein the system includes no polyester.

10. The system of claim 1 wherein the system includes no polypropylene.

11. The system of claim 1 wherein the system includes no polyethylene terephthalate.

12. The system of claim 1, further comprising a second polyethylene film including a second polyethylene layer, wherein the plurality of gas-filled polyethylene bubbles are attached directly to the second polyethylene layer of the second polyethylene film.

13. The system of claim 12 wherein the second polyethylene film is a second metallized polyethylene film including a second metallic layer and the second polyethylene layer.

14. The system of claim 13 wherein a second surface of the second metallic layer of the second metallized polyethylene film opposite to the second polyethylene layer of the second metallized polyethylene film is exposed to an environment surrounding the system.

15. A method of fabricating a system, comprising:
coupling a plurality of gas-filled polyethylene bubbles to a metallized polyethylene film including a metallic layer and the polyethylene layer, such that a surface of the metallic layer of the metallized polyethylene film opposite to the polyethylene layer of the metallized polyethylene film is exposed to an environment surrounding the system.
